(19) United States
(12) Patent Application Publication
(10) Pub. No.: US 2025/0283749 A1
(43) Pub. Date: Sep. 11, 2025

(54) TRANSFORMER OIL-LEVEL MONITORING AND EARLY WARNING SYSTEM

(71) Applicant: Fortune Electric Co., Ltd., Taoyuan City (TW)

(72) Inventors: CHIA-CHING LIN, Taoyuan City (TW); CHING-MIN CHEN, Taoyuan City (TW); YA-HUA LEE, Taoyuan City (TW)

(21) Appl. No.: 18/979,496

(22) Filed: Dec. 12, 2024

(30) Foreign Application Priority Data
Mar. 5, 2024 (TW) 113107805

(51) Int. Cl. G01F 23/292; H01F 27/32

(52) U.S. Cl. CPC G01F 23/292; H01F 27/321

(57) ABSTRACT

A transformer oil-level monitoring and early warning system includes a plurality of transformer apparatuses and a diagnosis management platform. Each of the transformer apparatuses includes an oil-immersed transformer and an intelligent oil-level detection device. The intelligent oil-level detection device is configured to acquire status information of an insulating oil for N consecutive days, and to generate a variation relationship curve between oil level height and oil temperature of each day within the N days according to the status information and perform fitting processing. Therefore, a standard reference curve adapted to the oil-immersed transformer is generated. The diagnosis management platform is configured to, for each of the transformer apparatuses, perform the operations of determining whether the oil-immersed transformer in operation has an oil level abnormality based on the standard reference curve and, if yes, provide an early warning notification.

### CROSS-REFERENCE TO RELATED PATENT APPLICATION

This application claims the benefit of priority to Taiwan Patent Application No. 113107805, filed on Mar. 5, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to transformer operation status monitoring and management system, and more particularly to a transformer oil-level monitoring and early warning system.

### BACKGROUND OF THE DISCLOSURE

An oil-immersed transformer is a common piece of power equipment used to decrease a high voltage to a low voltage or increase a low voltage to a high voltage, the stable operation of which is directly related to power supply reliability of an electrical grid. The main feature of the oil-immersed transformer is that an iron core and windings are immersed in an insulating oil so as to improve insulation performance and prevent failure or ignition of electrical appliances from occurring. Furthermore, the insulating oil can effectively dissipate heat, so that the oil-immersed transformer can be maintained at a relatively stable temperature to have an improved operation efficiency and lifespan.

Generally, the temperature of an insulating oil increases as the load on a transformer increases, which can cause an oil level of the insulating oil to rise due to expansion. On the contrary, the temperature of the insulating oil decreases as the load on the transformer decreases, which can cause the oil level of the insulating oil to fall due to contraction. Therefore, oil level variations can reflect the health status of the transformer. If the oil level is too high or too low, the transformer may have an abnormal condition, causing transformer failure or even an accident. For example, a pressure inside an oil tank can increase to cause oil spillage when the oil level is too high, and the insulation performance of the transformer can decrease to cause insulation breakdown when the oil level is too low.

Therefore, an oil storage device of the transformer is equipped with an oil level gauge to monitor oil level variations of the insulating oil during operation. However, the transformer may operate in different working states or environments. Even if there is a standard (such as a reference curve describing a relationship between oil level and oil temperature) that can be used to judge the correctness of the oil level variations so as to determine whether the transformer is in normal operation, the standard cannot reflect an actual oil level height. A common procedure in the industry is to stop the operation of the transformer and then confirming an oil level once the oil level stabilizes. However, this procedure takes a long time, is complex to operate, and may cause power instability and financial losses in severe cases.

### SUMMARY OF THE DISCLOSURE

In response to the above-referenced technical inadequacies, the present disclosure provides a transformer oil-level monitoring and early warning system, which can provide each transformer in a power system a dedicated standard for determining an oil level abnormality, and can monitor and manage oil level variations of a transformer during operation and provide early warning accordingly.

In order to solve the above-mentioned problems, one of the technical aspects adopted by the present disclosure is to provide a transformer oil-level monitoring and early warning system, which includes a plurality of transformer apparatuses and a diagnosis management platform. Each of the transformer apparatuses includes an oil-immersed transformer and an intelligent oil-level detection device, and the oil-immersed transformer includes an oil storage device and an insulating oil located in the oil storage device. The intelligent oil-level detection device is connected to the oil storage device and includes a sensing module and a data processing module coupled to the sensing module. The sensing module is configured to acquire status information of the insulating oil for N consecutive days. The status information includes, at each unit time point of each day within the N days, an oil temperature, and an oil level height at the oil temperature, where N is an integer greater than 1. The data processing module is configured to generate a variation relationship curve between oil level height and oil temperature of each day within the N days according to the status information of the insulating oil and perform fitting processing, so as to generate a standard reference curve adapted to the oil-immersed transformer. The diagnosis management platform is configured to, for each of the transformer apparatuses, perform the operations of determining whether the oil-immersed transformer in operation has an oil level abnormality based on the standard reference curve and, if yes, provide an early warning notification.

In conclusion, the transformer oil-level monitoring and early warning system can remotely monitor oil level variations of each transformer being in operation in a power system and overcome differences in operating environments or conditions, and can immediately ascertain an oil level abnormality of each transformer, so as to promptly provide a notification and implement appropriate measures. Therefore, the purposes of effectively reducing troubleshooting time, preventing the transformers from being damaged, and avoiding the occurrence or spreading of damages can be achieved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view showing an operational arrangement of a transformer oil-level monitoring and early warning system of the present disclosure;

FIG. 2 is another schematic view showing an operational arrangement of the transformer oil-level monitoring and early warning system of the present disclosure;

FIG. 3 is a schematic structural view of the transformer oil-level monitoring and early warning system of the present disclosure;

FIG. 4 is a partial schematic perspective view of a transformer apparatus of the present disclosure; and

FIG. 5 is a variation relationship curve between oil level height and oil temperature generated by an intelligent oil-level detection device of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The normal operation of a transformer is directly related to an oil level position (i.e., an oil level height) of an insulating oil. However, when the transformer operates under a different environment, the insulating oil may have a different relationship between oil level position and oil temperature, and it is thus difficult to determine whether an abnormal condition occurs by using a single standard. Therefore, a technical concept provided by the present disclosure is to collect status information of each transformer of a power system over multiple working days, which includes oil level height data (i.e., measurement points) at different oil temperatures, and then to generate an optimum standard reference curve of correlation between oil level height and oil temperature by fitting processing, so as to quickly and accurately determine whether a transformer in operation has an oil level abnormality.

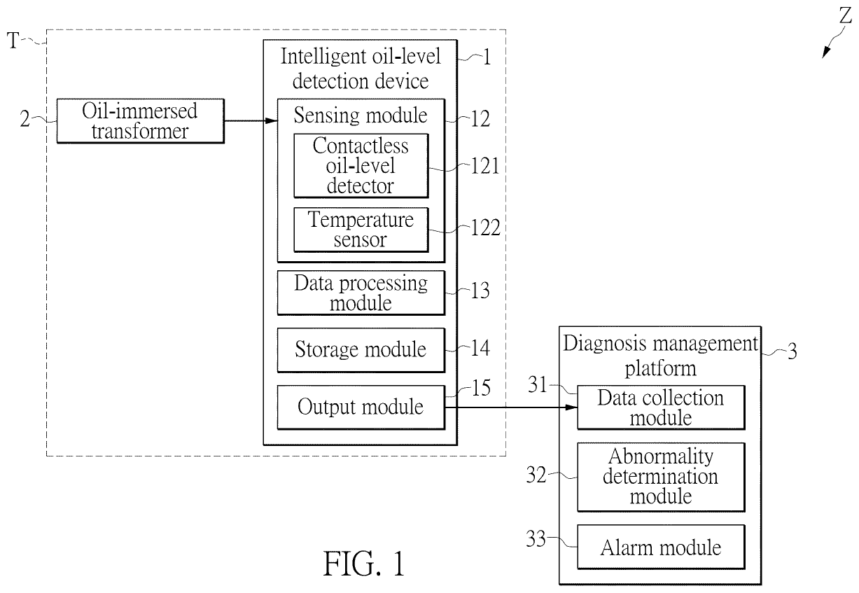

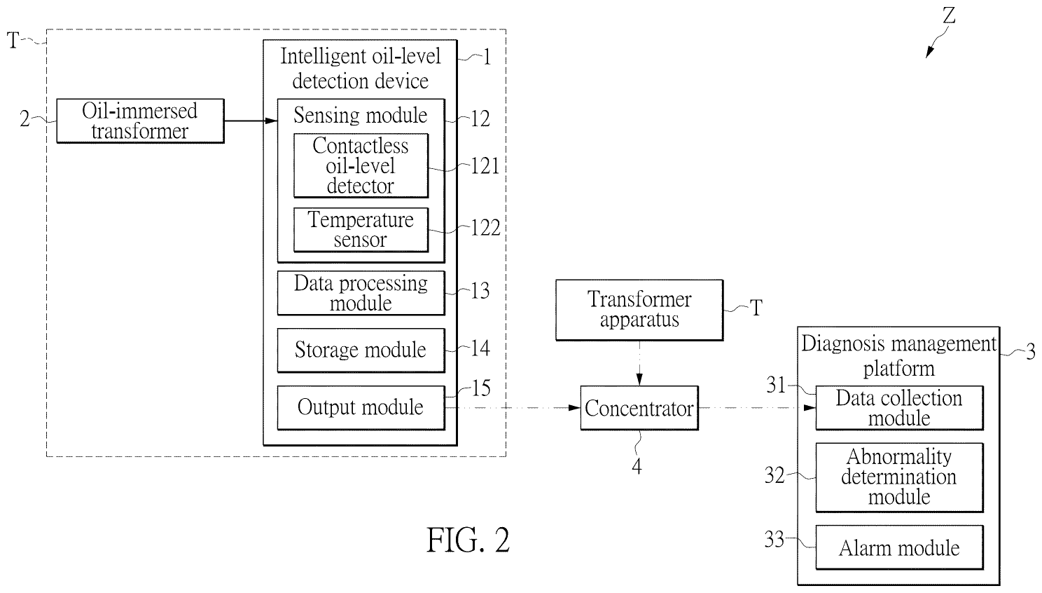

Referring to FIG. 1 and FIG. 2, an operational configuration of a transformer oil-level monitoring and early warning system Z of the present disclosure is shown. The transformer oil-level monitoring and early warning system Z of the present disclosure concretely embodies the above-mentioned concepts, and mainly includes a plurality of transformer apparatuses T and a diagnosis management platform 3. The diagnosis management platform 3 can establish communication connections with the transformer apparatuses T, so as to monitor oil level variations and provide early warning on an abnormity accordingly. The diagnosis management platform 3 can be implemented on a network-enabled computer device, but the present disclosure is not limited thereto.

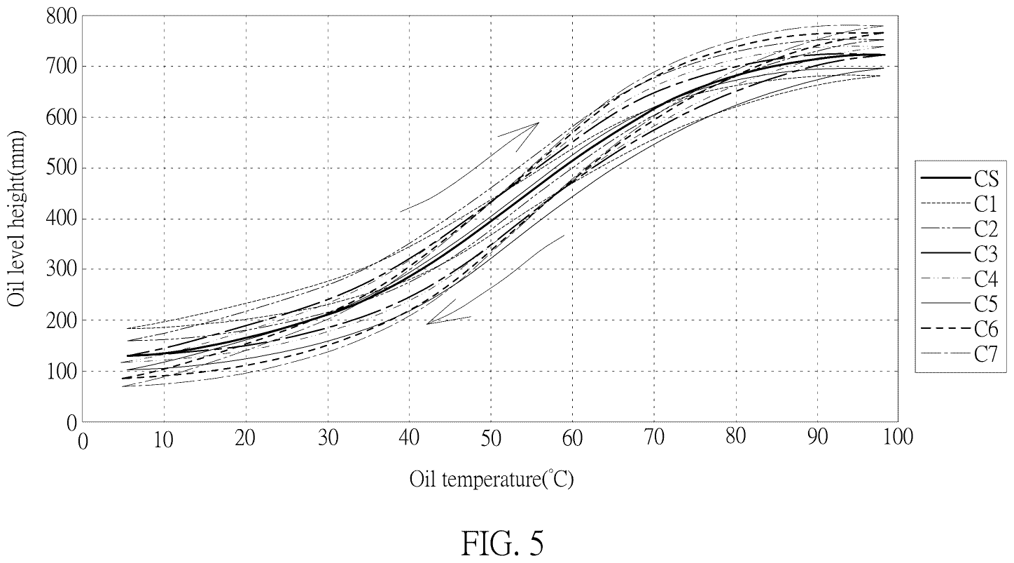

Reference is made to FIG. 5, in which each of the transformer apparatuses T includes an intelligent oil-level detection device 1 and an oil-immersed transformer 2. In use, the intelligent oil-level detection device 1 is configured to acquire status information of an insulating oil of the oil-immersed transformer 2 over multiple consecutive days and perform fitting processing on the status information, so as to generate a standard reference curve CS of a variation correlation between operating oil level position and oil temperature, which is adapted to the oil-immersed transformer 2. The diagnosis management platform 3 is configured to, for each of the transformer apparatuses T, perform the operations of determining whether the oil-immersed transformer 2 in operation has an oil level abnormality and, if yes, provide an early warning notification.

More specifically, the intelligent oil-level detection device 1 can include a chassis 11, a sensing module 12, and a data processing module 13, and the chassis 11 is configured to integrate the sensing module 12 and the data processing module 13 with an oil storage device 21 of the oil-immersed transformer 2. For example, the chassis 11 can be physically coupled to the oil storage device 21, and the data processing module 13 can be disposed in the chassis 11 and electrically coupled to the sensing module 12, but the present disclosure is not limited thereto. In use, the sensing module 12 can acquire operating status parameters of the oil-immersed transformer 2 by detecting, for example, oil temperatures and oil level heights of an insulating oil 22. The data processing module 13 can perform programmatic steps of data analysis, numerical calculation, simulation, and correction, and the results can serve as the basis for determining whether the oil-immersed transformer 2 is in normal operation and can be practically applied to the operation, maintenance and repair of oil-immersed transformer 2.

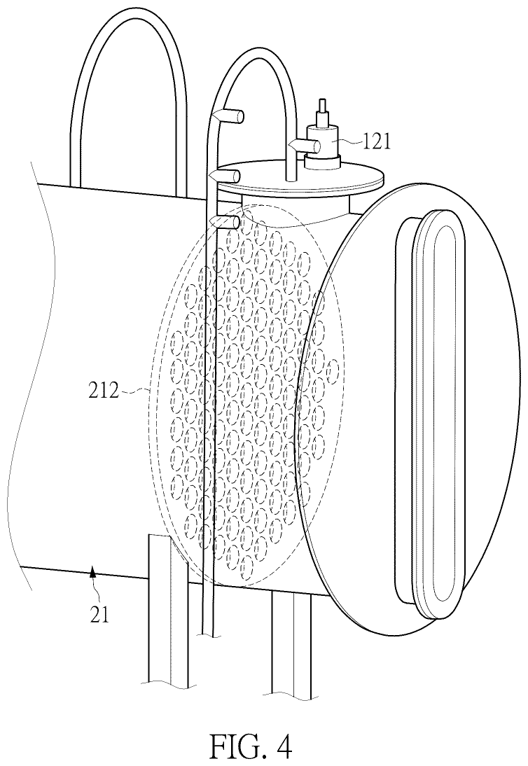

In the present disclosure, the sensing module 12 is configured to acquire status information of the insulating oil for N consecutive days. The status information of the insulating oil includes, at each unit time point of each day within the N days, an oil temperature, and an oil level height at the oil temperature, where N is an integer greater than 1. A unit time point refers to a time point that passes one or more predetermined time intervals, which can be set freely, from a starting time point. The data processing module 13 is configured to generate a variation relationship curve C1-C7 between oil level height and oil temperature of each day within the N days according to the status information of the insulating oil and perform fitting processing. Examples of fitting processing include, but are not limited to, curve fitting. Accordingly, a standard reference curve CS adapted to the oil-immersed transformer 2 is generated to serve as the basis for judging abnormal conditions, and can be used to determine whether the oil-immersed transformer 2 in operation has an abnormal oil level. It should be noted that the standard reference curve CS as shown in FIG. 4 is only an example, and does not encompass all possible situations. In practice, the fitted curve can vary with different transformers.

In the present embodiment, the sensing module 12 can acquire current operating status parameters of the oil-immersed transformer 2 at regular time intervals (e.g., at 10-minute or 1-hour intervals) within a predetermined period of time of each day within the N days, which mainly includes oil temperatures and oil level heights of the insulating oil 22. The predetermined period of time preferably includes a high temperature period and a low temperature period of one day, which can range from, but is not limited to, 12 o'clock at night to 2 o'clock in the afternoon. The data processing module 13 can use oil level height data (i.e., measurement points) at different oil temperatures to generate a variation relationship curve between oil level height and oil temperature of the Mth day within the N days by data fitting, where M is an integer and M≤N. In the example of the sensing module 12 acquiring operating status parameters of the oil-immersed transformer 2 for seven consecutive working days, the data processing module 13 can perform data fitting so as to generate a variation relationship curve C1 between oil level height and oil temperature of the first day, a variation relationship curve C2 between oil level height and oil temperature of the second day, a variation relationship curve C3 between oil level height and oil temperature of the third day, a variation relationship curve C4 between oil level height and oil temperature of the fourth day, a variation relationship curve C5 between oil level height and oil temperature of the fifth day, a variation relationship curve C6 between oil level height and oil temperature of the sixth day, and a variation relationship curve C7 between oil level height and oil temperature of the seventh day. However, such example is not meant to limit the scope of the present disclosure.

The data processing module 13 can perform approximate simulation of fitting function curves, which uses an n-degree polynomial to describe a conversion function relationship between oil level height and oil temperature. Therefore, the resulting standard reference curve CS can be optimally adapted to the oil-immersed transformer 2 that operates under specific operational conditions or in a specific environment.

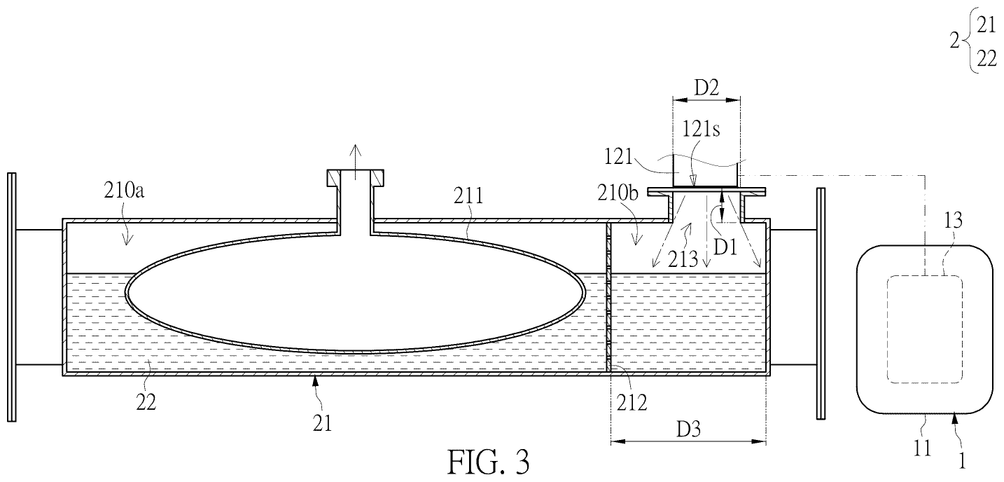

Reference is made to FIG. 1, which is to be read in conjunction with FIG. 3. The sensing module 12 can include a contactless oil-level detector 121 and an oil temperature sensor 122. The contactless oil-level detector 121 can be appropriately arranged or configured to detect an oil level position (i.e., an oil level height) of the insulating oil 22 by lighting. The oil temperature sensor 122 can be appropriately arranged or configured to detect an oil temperature in direct contact with a top layer of the insulating oil 22. The data processing module 13 can be a processing unit of a microcontroller or a general-purpose or special-purpose processor. However, the above examples are not meant to limit the scope of the present disclosure. Furthermore, the intelligent oil-level detection device 1 can further increase a storage module 14 for storing data obtained by the sensing module 12 and results output by the data processing module 13. The storage module 14 can be, but is not limited to, a storage unit of the microcontroller or any form of memory.

It is worth mentioning that the data processing module 13 can repeatedly and regularly perform the above operations so as to update the standard reference curve CS dedicated to the oil-immersed transformer 2. For example, the data processing module 13 can provide a new standard reference curve CS or correct a curve feature of the standard reference curve CS (such as a curve range or a radius of curvature or slope on the curve) every quarter or half an year according to status information of the insulating oil within another N days, where N is an integer greater than 1.

In one embodiment of the present embodiment, the diagnosis management platform 3 can include a data collection module 31, an abnormality determination module 32, and an alarm module 33. Each module can be a software, hardware, or firmware. The data collection module 31 can be connected to a wired network, so as to establish a communication connection with the intelligent oil-level detection device 1 of each of the transformer apparatuses T, as shown in FIG. 1. Alternatively, the data collection module 31 can be connected to a wireless network, so as to establish a communication connection with the intelligent oil-level detection device 1 of each of the transformer apparatuses T through a concentrator 4 (e.g., a data concentration unit), as shown in FIG. 2. Therefore, the intelligent oil-level detection device 1 of each of the transformer apparatuses T can transmit original data or processed data to the diagnosis management platform 3 by an output module 15. The output module 15 can be, but is not limited to, a communication module or an output interface. The abnormality determination module 32 can set a threshold value according to the features of the standard reference curve CS and determine whether an actual oil level height of the insulating oil 22 is higher or lower than the threshold value. The alarm module 33 sends an early warning notification to related personnel such as maintenance personnel when the determination result is yes. The early warning notification includes abnormal status information, hardware device information, and location information related to the oil-immersed transformer 2, so that response measures (e.g., oil replenishment) can be promptly implemented. However, the above description is disclosed for exemplary purposes only, and is not meant to limit the scope of the present disclosure.

In practice, the diagnosis management platform 3 can inspect and use information in the intelligent oil-level detection device 1 when executing a software application. Alternatively, the data collection module 31 can periodically send a request to the intelligent oil-level detection device 1 to inquire about a current operating status of the oil-immersed transformer 2. Then, the intelligent oil-level detection device 1 responds and transmits back operating status parameters (e.g., actual oil temperatures and actual oil level heights of the insulating oil 22) detected by the sensing module 12 to the data collection module 31 through the output module 15. Alternatively, the intelligent oil-level detection device 1 can actively transmit data to operating status parameters detected by the sensing module 12 to the data collection module 31 through the output module 15.

In practice, the abnormality determination module 32 can set an upper limit value of oil level height and a lower limit value of oil level height that corresponds to each temperature point within a temperature range encompassing actual oil temperatures according to the standard reference curve CS. Alternatively, the abnormality determination module 32 can use a machine learning model to correct or reconstruct the standard reference curve CS, and can set the upper limit values of oil level height and the lower limit values of oil level height according to the standard reference curve CS being corrected or reconstructed. Then, the abnormality determination module 32 determines whether an actual oil level height is higher than the upper limit value of oil level height or lower than the lower limit value of oil level height, and if yes, determines that the oil-immersed transformer 2 in operation has an oil level abnormality. Preferably, the machine learning model can be trained with operational environment data (e.g., temperature data of surroundings), operational condition data (e.g., load data), temperature and oil level data, and historical variation relationship curves between oil level height and oil temperature.

Reference is made to FIG. 1 and FIG. 2, which are to be in conjunction with FIG. 3 and FIG. 4. In the present disclosure, the oil storage device 21 includes an air cell 211 disposed therein to isolate the insulating oil from the atmosphere, and the air cell 211 is located outside a sensing range of the contactless oil-level detector 121. The air cell 211 is configured to be in communication with the atmosphere for exhaust or suction. Furthermore, the oil storage device 21 includes a partitioning plate 212, and a first oil chamber 210a and a second oil chamber 210b in the oil storage device 21 are separated from and in communication with each other by the partitioning plate 212. More specifically, the air cell 211 is disposed in the first oil chamber 210a. The contactless oil-level detector 121 has a light emitting surface 121s that corresponds in position to the second oil chamber 210b. Therefore, the air cell 211 will not block a light output path of the contactless oil-level detector 121 even if it expands, thereby ensuring the normal operation of the contactless oil-level detector 121.

In practice, the oil storage device 21 includes an inlet opening 213 that is arranged between the light emitting surface 121s and the second oil chamber 210b to allow light emitted from the light emitting surface 121s to enter the second oil chamber 210b and irradiate the oil surface of the insulating oil 22. The light emitting surface 121s and the inlet opening 213 have a predetermined distance D1 therebetween. The inlet opening 213 has a width D2. The second oil chamber 210b has an interior width D3. The ratio of the predetermined distance D1, the width D2, and the interior width D3 is 1:5-8:14-17, and preferably 1:6:17.

### BENEFICIAL EFFECTS OF THE EMBODIMENTS

The transformer oil-level monitoring and early warning system can remotely monitor oil level variations of each transformer being in operation in a power system and overcome differences in operating environments or conditions, and can immediately ascertain an oil level abnormality of each transformer, so as to promptly provide a notification and implement appropriate measures. Therefore, the purposes of effectively reducing troubleshooting time, preventing the transformers from being damaged, and avoiding the occurrence or spreading of damages can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A transformer oil-level monitoring and early warning system, comprising a plurality of transformer apparatuses and a diagnosis management platform, each of the transformer apparatuses including:
an oil-immersed transformer including an oil storage device and an insulating oil located in the oil storage device;
an intelligent oil-level detection device connected to the oil storage device and including a sensing module and a data processing module coupled to the sensing module;
wherein the sensing module is configured to acquire status information of the insulating oil for N consecutive days, and the status information includes, at each unit time point of each day within the N days, an oil temperature and an oil level height at the oil temperature, where N is an integer greater than 1;
wherein the data processing module is configured to generate a variation relationship curve between oil level height and oil temperature of each day within the N days according to the status information of the insulating oil and perform fitting processing, so as to generate a standard reference curve adapted to the oil-immersed transformer;
wherein the diagnosis management platform is configured to, for each of the transformer apparatuses, perform the following operations:
determining whether the oil-immersed transformer in operation has an oil level abnormality based on the standard reference curve; and
providing an early warning notification when the oil-immersed transformer in operation has the oil level abnormality.

2. The transformer oil-level monitoring and early warning system according to claim 1, wherein the fitting processing is performed by using a curve equation.

3. The transformer oil-level monitoring and early warning system according to claim 1, wherein the sensing module is configured to acquire an actual oil temperature and an actual oil level height of the insulating oil, and the diagnosis management platform is configured to set an upper limit value of oil level height and a lower limit value of oil level height that corresponds to a predetermined temperature equal to the actual oil temperature according to the standard reference curve, and to determine whether the actual oil level height is higher than the upper limit value of oil level height or lower than the lower limit value of oil level height; wherein the diagnosis management platform determines that the oil-immersed transformer in operation has the oil level abnormality when the actual oil level height is higher than the upper limit value of oil level height or lower than the lower limit value of oil level height.

4. The transformer oil-level monitoring and early warning system according to claim 1, wherein the sensing module is configured to acquire an actual oil temperature and an actual oil level height of the insulating oil, and the diagnosis management platform is configured to use a machine learning model to correct or reconstruct the standard reference curve and set an upper limit value of oil level height and a lower limit value of oil level height that corresponds to a predetermined temperature equal to the actual oil temperature according to the standard reference curve being corrected or reconstructed, and to determine whether the actual oil level height is higher than the upper limit value of oil level height or lower than the lower limit value of oil level height; wherein the diagnosis management platform determines that the oil-immersed transformer in operation has the oil level abnormality when the actual oil level height is higher than the upper limit value of oil level height or lower than the lower limit value of oil level height.

5. The transformer oil-level monitoring and early warning system according to claim 1, further comprising a concentrator, wherein the diagnosis management platform establishes a communication connection with the intelligent oil-level detection device of each of the transformer apparatuses through the concentrator.

6. The transformer oil-level monitoring and early warning system according to claim 1, the sensing module includes a contactless oil-level detector and an oil temperature sensor for acquiring the status information of the insulating oil.

7. The transformer oil-level monitoring and early warning system according to claim 6, wherein the contactless oil-level detector is disposed towards an oil surface of the insulating oil, the oil storage device includes an air cell disposed therein to isolate the insulating oil from the atmosphere, and the air cell is located outside a sensing range of the contactless oil-level detector.

8. The transformer oil-level monitoring and early warning system according to claim 7, wherein the oil storage device includes a partitioning plate, and a first oil chamber and a second oil chamber in the oil storage device are separated from and in communication with each other by the partitioning plate; wherein the air cell is disposed in the first oil chamber, and the contactless oil-level detector has a light emitting surface that corresponds in position to the second oil chamber.

9. The transformer oil-level monitoring and early warning system according to claim 8, wherein the oil storage device includes an inlet opening that is arranged between the light emitting surface and the second oil chamber to allow light emitted from the light emitting surface to enter the second oil chamber and irradiate the oil surface of the insulating oil.

10. The transformer oil-level monitoring and early warning system according to claim 9, wherein the light emitting surface and the inlet opening have a predetermined distance therebetween, the inlet opening has a width, the second oil chamber has an interior width, and a ratio of the predetermined distance, the width, and the interior width is 1:6:14.
